(19) United States
(12) Patent Application Publication
(10) Pub. No.: US 2019/0041514 A1
(43) Pub. Date: Feb. 7, 2019

(54) METHOD AND APPARATUS FOR DRIVING HAZARD DETECTION

(71) Applicant: FORD GLOBAL TECHNOLOGIES, LLC, Dearborn, MI (US)

(72) Inventors: Alejandro Israel GARCIA SOLACHE, Mexico City (MX); Mauricio GARCIA, Coyoacan (MX); Jordi VIDAURI, Coyoacan (MX); Jose Manuel RIVERA, Mexico City (MX)

(21) Appl. No.: 15/665,550

(22) Filed: Aug. 1, 2017

(51) Int. Cl. G01S 13/94; G05D 1/02; G01S 13/42

(52) U.S. Cl. CPC G01S 13/94; G05D 1/0253; G05D 1/0214; B60W 2550/147; G05D 1/0242; G05D 2201/0213; G06T 2207/30252; G01S 13/426

(57) ABSTRACT

A system includes an automotive-based processor configured to receive a road-scanning instruction. The processor is further configured to instruct a vehicle-mounted sonar to scan an upcoming section of terrain and receive scan data from the sonar, responsive to the instruction. The processor is additionally configured to convert the scan data to a visual display showing at least obstacles and elevations and present the visual display on an in-vehicle display.

### TECHNICAL FIELD

The illustrative embodiments generally relate to methods and apparatuses for driving hazard detection.

### BACKGROUND

Many automotive manufactures produce vehicles capable of off-road or dirt-road driving. A subset of drivers enjoys driving these types of vehicles, and the vehicles typically are designed to handle a variety of potential hazards. Because of the nature of the driving conditions, however, even well-designed vehicles can encounter issues such as large hidden rocks, stumps, holes, etc. Since the vehicle is not being driven on a paved road, the driver will frequently have difficulty visually identifying some of these hazards.

Many of these vehicles can also be driven in inclement weather over uneven terrain. In wet or snowy conditions, it is very easy for an obstruction to become visually obscured, either underwater or under snow.

Even standard on-road vehicles can encounter problems with water and snow visual impairment. When flooding occurs, a road that appears passable may actually have a deep portion that would flood an engine if the driver drove through the water. The driver may not know about a dip or drop in the road, and may proceed through what appears to be low-water, only to encounter a depth that effectively disables the engine.

### SUMMARY

In a first illustrative embodiment, a system includes an automotive-based processor configured to receive a road-scanning instruction. The processor is further configured to instruct a vehicle-mounted sonar to scan an upcoming section of terrain and receive scan data from the sonar, responsive to the instruction. The processor is additionally configured to convert the scan data to a visual display showing at least obstacles and elevations and present the visual display on an in-vehicle display.

In a second illustrative embodiment, a computer-implemented method includes scanning a section of road ahead of a vehicle using on-board sonar, responsive to an occupant scan instruction. The method further includes converting sonar scan data to a visual image, showing at least road-obstacles and presenting the visual image on an in-vehicle display.

In a third illustrative embodiment, a non-transitory storage medium stores instructions that, when executed by a processor, cause the processor to perform a method including receiving sonar data from vehicle mounted sonar, and an image from a vehicle mounted camera, the sonar data and image both taken for a section of road ahead of a vehicle and responsive to an occupant instruction. The method further includes merging the sonar data and image into a digital representation showing the image with visual indications of obstacles and elevations, as measured by the sonar data, included therein and displaying the digital representation on an in-vehicle display.

### BRIEF DESCRIPTION OF THE DRAWINGS

FIG. 1 shows an illustrative vehicle computing system;

FIG. 2 shows an illustrative presentation of two views of a sonar-mapped road surface;

FIG. 3 shows an illustrative process for road-surface mapping; and

FIG. 4 shows an illustrative image presentation process.

### DETAILED DESCRIPTION

As required, detailed embodiments are disclosed herein; however, it is to be understood that the disclosed embodiments are merely illustrative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

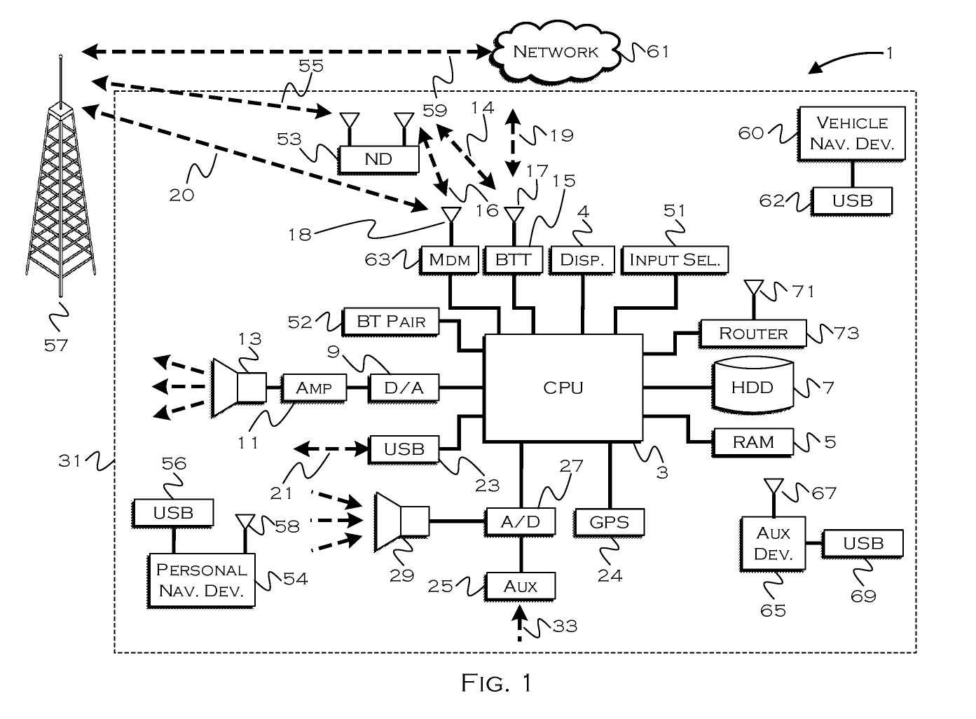

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a Wi-Fi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., Wi-Fi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

A potential difficulty encountered by off-road drivers, and, to a lesser extent, drivers in severe conditions, is that a vehicle obstruction can become visually obscured. Most off-road drivers do not want to proceed at a snail's pace while driving, in order to avoid damage or injury due to off-road conditions. While many on-road drivers may cautiously attempt to drive through water, for example, once an engine becomes sufficiently wet (such as if the spark plugs get wet), the vehicle will become disabled and a driver, even a cautious driver, will be stuck.

The illustrative embodiments propose use of SONAR or a similar sensing technology included on any suitable portion of the vehicle (e.g., front, rear, side, etc), capable of mapping hidden features of a road ahead, which can include, but is not limited to, soft spots, holes, rocks and logs and even depths of water or snow. Using such technology can allow a driver to proceed with relative confidence that a vehicle will not become stuck or damaged, and the driver can avoid identified obstructions or drive slowly over them. The sensing technology may be able to sense in multiple directions, or may be disposed on portions of a vehicle corresponding to where sensing is desired.

Sensing technology capable of mapping objects based on reflective capabilities and/or density can provide an image of a road that highlights distinctions in density or the presence of objects. In a similar manner, the technology can provide depth information for snow or water, since the ground will be denser and more reflective than the substance atop it (when that substance is water-based, at least). A camera image can also be provided to a driver, and/or presented as merged with SONAR data. This allows the driver to more easily see what is immediately ahead of a vehicle.

When a driver encounters a condition of questionable driving quality, the driver can approach the edge of the condition and request a scan of the road ahead. A scan and visual image can provide the driver, via a vehicle HMI, with visual data indicating any potential hazards and the general condition (and depth, if applicable) of the upcoming road. Since a vehicle is capable of knowing a safe driving “depth,” the illustrative embodiments can also alert a driver to a likely disabling condition, if the vehicle is not designed to travel through a detected depth of water or snow.

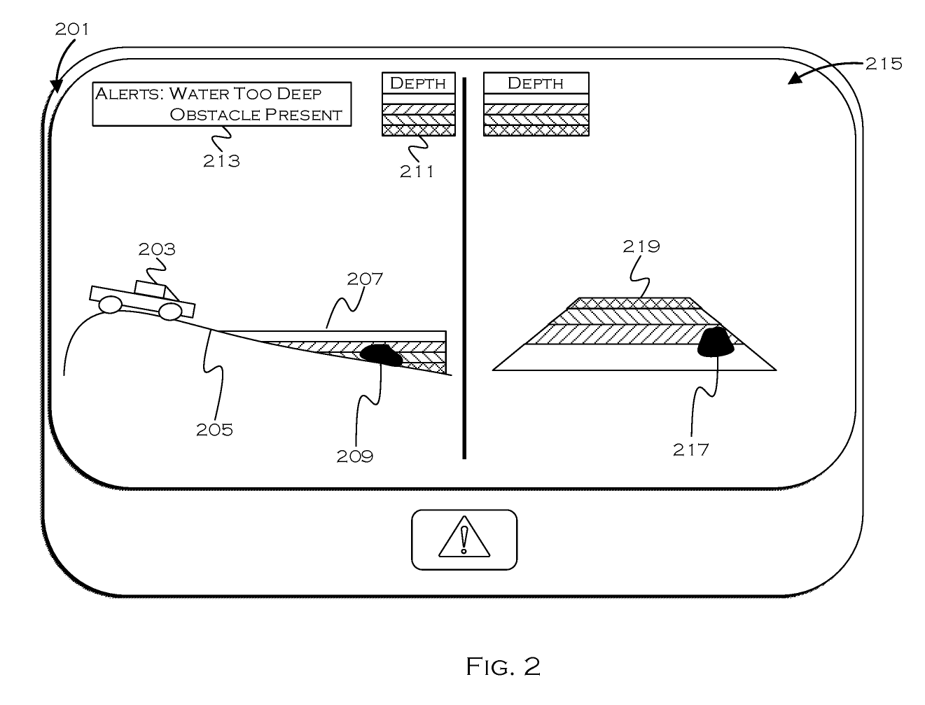

FIG. 2 shows an illustrative presentation of two views of a sonar-mapped road surface. This Figure shows two example displays that may be presented on a vehicle HMI 201, when a driver approaches or encounters an area of concern. On the left side is a projected front view. The data shown is extrapolated in this example, since there is not typically going to be a camera showing a side view of the vehicle looking towards the vehicle (unless the vehicle had a drone, for example).

Based on obtained sensor data, an illustrative process can display the vehicle 203, proximity to water 207 and a road 205 elevation profile. Here, the profile includes water 207 of varied detected depths and an obstruction 209 hidden under the water but detected by the SONAR.

A legend 211 shows the various measured water depths, which could include highlighting or changing the color of depths through which the vehicle was not built to travel. The display also includes an alert 213 section, which presents the driver with any critical alerts that could be relevant to the upcoming driving. In this instance, the water is too deep and there is a hidden obstacle present.

A second viewpoint 215 shows a front-ward view of the road ahead, which could be captured from a vehicle camera or digitally represented, and includes sensor data representative of detected conditions. This view could be seen from an perspective of any camera, based on what the particular camera can see and/or where the camera is mounted. Here, the road is shown going forward (digitally inserted if not visually available) and the approximate position of the detected obstacle 217 is represented. This view would allow the driver to navigate around the obstacle 217, by veering left.

This view also shows elevation lines 219 representing water depth, and again the user could be alerted or notified (visually, audibly or both) if the water was too deep for travel. If the vehicle was likely, beyond a threshold percentage, to become disabled by proceeding, the vehicle could even prevent forward driving beyond a point if desired, in order to automatically prevent excessive damage or shutdown. So, for example, if testing revealed a 50% chance that the vehicle could progress through 2.5 feet of water over a 3 foot stretch, then the vehicle may be allowed to proceed with a warning, but if there was a 90% chance of engine failure then the vehicle may be prevented from proceeding. This safety feature could also be owner-engageable or disableable if desired and permitted.

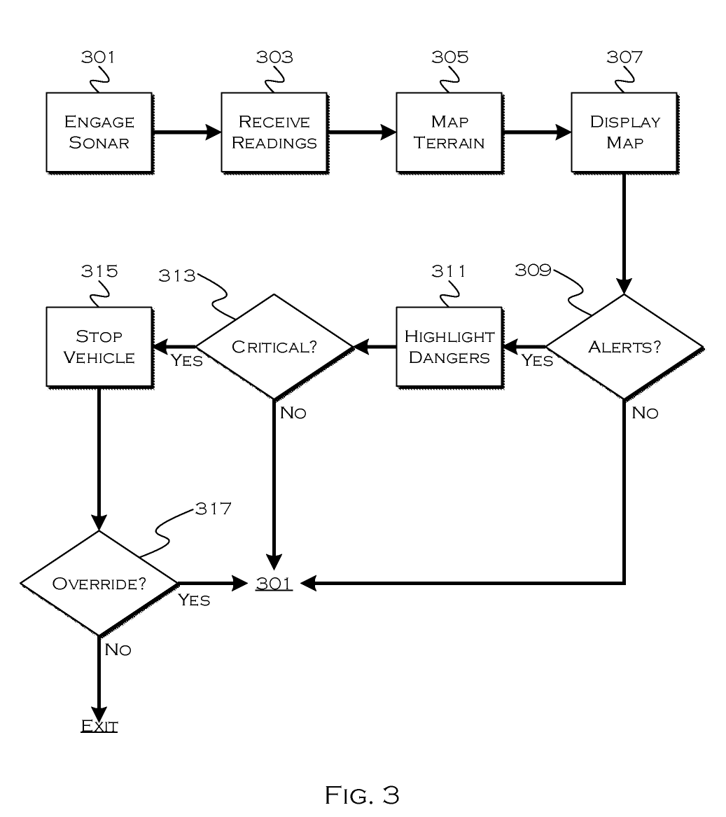

FIG. 3 shows an illustrative process for road-surface mapping. In this example, the process begins when requested by a user, which is typically when a user has approached a questionable driving-region. While the process could be an ongoing one, the accuracy might suffer because of vehicle movement, and more accurate results may be obtained by approaching an area to be mapped, stopping and engaging the SONAR. The quality and rapidity of detection may also play a factor in which technique is, or needs to be, employed.

The process engages 301 the vehicle SONAR and receives 303 readings of the objects and surface conditions within a scannable SONAR field. The process then uses this data to map 305 upcoming terrain. This can include, for example, identifying obstacles, identifying soft areas of a road ahead, depth mapping, surface mapping and any other desirable result constructable from the measured and detected data.

The process then displays 307 a visual representation of the area ahead, which can include either of the views shown in FIG. 2, a top-down representation, or any other suitable representation that visually indicates the presence of obstacles and/or driving conditions.

Analyzing the received sensor data may reveal that one or more dangerous conditions exists on the road ahead. In those instances, the process may identify 309 the conditions as alert conditions. The process may highlight 311 these conditions using a visual and/or audible indicator, such as, but not limited to, a visual alert, a visual indicator around the condition, an audible alarm, etc.

Some of the conditions may be “critical conditions” 313 that could result in severe damage to a vehicle or occupant. For example, a vehicle driving through snow could become aware of a buried chasm or lake ahead, and the driver would have no idea if the snow obscured the view. In such an instance, the vehicle could automatically stop 315 and provide a reason to the driver why the vehicle halted. If permissible, the driver could override 317 the stop command and keep moving, but certain conditions (large buried holes, unclearable obstructions, etc) could result in states where no override was possible, due to legality or a near certainty of severe physical injury or vehicle disablement.

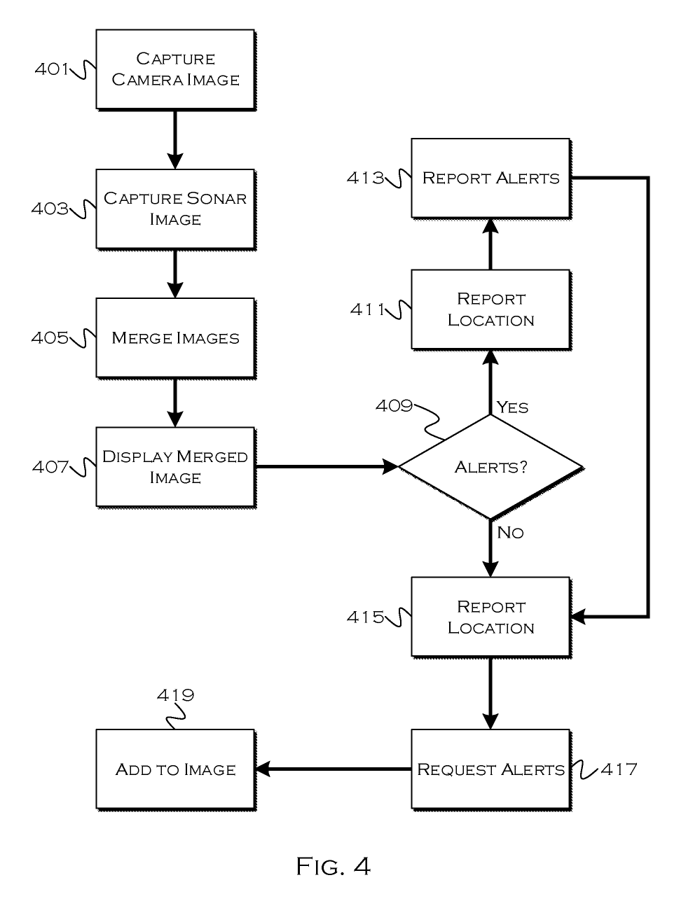

FIG. 4 shows an illustrative image presentation process. In this example, the process blends camera and SONAR images, to present a visual view of an upcoming driving condition augmented with improved information about conditions that may not be otherwise visually detectable.

The process captures 401, 403 both a forward camera and SONAR image of an upcoming region. Depending on the angle and quality of the camera and SONAR, the process may also instruct the driver to move closer to a questionable area, and may continue this repetition until a suitable data set is obtained. Since a road/ground surface will typically be a dense and detectable object, the process can generally “know” whether or not it has captured a suitable set of data that includes data all the way down to a ground level. Put another way, if the ground simply appears not to exist, then there is either a large hole (e.g., pit, lake, chasm), incredibly soft ground, or the vehicle angle is preventing an accurate SONAR image.

Once suitable versions of both the camera and SONAR images have been captured, the process merges 405 the data from both images, to obtain a realistic view of upcoming terrain augmented with SONAR data. The process then displays 407 this image so the driver can see an improved and augmented view of the upcoming terrain.

As before, the process may determine 409 if any alert conditions exist with respect to the upcoming terrain. If there are alerts, the process reports 411 a location and reports 413 the alert to a remote database (if a connection is available). While many off road conditions will only be encountered by one or a few vehicles, ever, having a repository of these conditions can allow for augmented information when SONAR data is unavailable or questionably accurate. While the process is reporting the alerts, the process can also report 415 a current location and request 417 any alerts previously associated with that location. This could include, for example, other SONAR readings taken by other vehicles and any actual conditions encountered by other vehicles proceeding through the condition. This sort of data may be more useful on commonly traveled roads or trails, where multiple vehicles are more likely to add to an existing condition data set.

Once any alerts are detected and/or received, the process then adds 419 the visual indicators to the displayed image, and adds any audible alerts. The process then displays the image for the driver, which now includes the alerts.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

What is claimed is:

1. A system comprising:
an automotive-based processor configured to:
receive a road-scanning instruction;
instruct a vehicle-mounted sonar to scan an upcoming section of terrain;
receive scan data from the sonar, responsive to the instruction;
convert the scan data to a visual display showing at least obstacles and elevations; and
present the visual display on an in-vehicle display.

2. The system of claim 1, wherein the processor is further configured to:
instruct a vehicle camera to take a picture of the upcoming section of terrain;
receive image data of the terrain from the vehicle camera; and
convert the scan data to the visual display by overlaying elevation and obstacle data, available from the scan data, onto the image data.

3. The system of claim 1, wherein the display showing the obstacles includes a digital representation of a physical obstruction on the upcoming terrain, hidden from view.

4. The system of claim 1, wherein the display showing the obstacles includes a digital representation of a surface consistency deviation on the upcoming terrain.

5. The system of claim 1, wherein the display showing the elevations shows the elevations as depths of a liquid covering the upcoming terrain.

6. The system of claim 1, wherein the processor is further configured to:
determine a vehicle engine failure likelihood, based on a vehicle traveling through a liquid covering the upcoming terrain, and at least on a liquid depth measured by the scan data; and
alert a vehicle occupant to the failure likelihood.

7. The system of claim 6, wherein the processor is further configured to:
determine that the failure likelihood is above a predetermined threshold and responsively prevent vehicle travel over the upcoming terrain through any region for which the failure likelihood is above the predetermined threshold.

8. The system of claim 1, wherein the processor is further configured to:
determine a vehicle damage likelihood, based on a vehicle encountering an obstacle, identified by the scan data, on the upcoming terrain; and
alert a vehicle occupant to the vehicle damage likelihood.

9. The system of claim 1, wherein the processor is further configured to:
determine a critical danger likelihood, based on the scan data, on the upcoming terrain, the critical danger likelihood representing at least one of a likely destruction of vehicle, health risk, or engine shut-down, above a predetermined threshold likelihood;
alert a vehicle occupant to the critical danger likelihood; and
prevent the vehicle from traveling over the terrain to which the critical danger likelihood corresponds based on the scan data.

10. The system of claim 1, wherein the processor is configured to highlight areas of risk, as determined from the scan data, on the visual display.

11. The system of claim 10, wherein the processor is configured to provide a visual text or audible alert corresponding to the areas of risk, identifying the risk.

12. A computer-implemented method comprising:
scanning a section of road ahead of a vehicle using on-board sonar, responsive to an occupant scan instruction;
converting sonar scan data to a visual image, showing at least road-obstacles; and
presenting the visual image on an in-vehicle display.

13. The method of claim 12, wherein the road-obstacles include a digital representation of a physical obstruction on the road, hidden from view.

14. The method of claim 12, wherein the obstacles include a digital representation of a surface consistency deviation on the road.

15. The method of claim 12, further comprising showing elevation lines representing depth of a substance covering the road.

16. The method of claim 15, wherein the substance includes water.

17. The method of claim 12, further comprising:
obtaining a photograph of the road from a vehicle camera; and
wherein the converting includes merging the photograph and the sonar scan data to produce the visual image, such that the visual image shows the photograph with the sonar scan data represented visually thereon.

18. The method of claim 12, further comprising:
determining a vehicle engine failure likelihood, based on a vehicle traveling through a substance covering the section of road ahead, and at least on a substance depth measured by the scan data; and
alerting a vehicle occupant to the failure likelihood.

19. The method of claim 18, further comprising:
determining that the failure likelihood is above a predetermined threshold and responsively preventing vehicle travel over the section of road ahead through any region for which the failure likelihood is above the predetermined threshold.

20. A non-transitory storage medium, storing instructions that, when executed by a processor, cause the processor to perform a method comprising:
receiving sonar data from vehicle mounted sonar, and an image from a vehicle mounted camera, the sonar data and image both taken for a section of road ahead of a vehicle and responsive to an occupant instruction;
merging the sonar data and image into a digital representation showing the image with visual indications of obstacles and elevations, as measured by the sonar data, included therein; and
displaying the digital representation on an in-vehicle display.
